(19) United States
(12) Patent Application Publication
(10) Pub. No.: US 2018/0067583 A1
(43) Pub. Date: Mar. 8, 2018

(54) MUTUAL CAPACITIVE TOUCH PANEL

(71) Applicant: MStar Semiconductor, Inc., Hsinchu Hsien (TW)

(72) Inventor: Ping-Yu CHAN, Hsinchu Hsien (TW)

(21) Appl. No.: 15/668,838

(22) Filed: Aug. 4, 2017

(30) Foreign Application Priority Data
Sep. 7, 2016 (TW) 105128880

(51) Int. Cl. G06F 3/044; G06F 3/041

(52) U.S. Cl. CPC G06F 3/044; G06F 3/0416

(57) ABSTRACT

A mutual capacitive touch panel includes at least one touch sensing group extending along a first direction. The touch sensing group includes a plurality of first electrodes, a plurality of second electrodes, a plurality of third electrodes and a plurality of fourth electrodes. The first electrodes are electrically connected, the second electrodes are electrically connected, and the first electrodes and the second electrodes are sequentially alternately arranged along the first direction. The third electrodes and the fourth electrodes are arranged along the first direction. One of the third electrodes and the adjacent fourth electrode are respectively disposed at one side of the corresponding first electrode and one side of the corresponding second electrode, and are electrically connected.

This application claims the benefit of Taiwan application Serial No. 105128880, filed Sep. 7, 2016, the subject matter of which is incorporated herein by reference.

### BACKGROUND OF THE INVENTION

### Field of the Invention

The invention relates in general to a mutual capacitive touch panel, and more particularly, to a single-layer mutual capacitive touch panel capable of reducing the number of pads.

### Description of the Related Art

With the progress of technologies, touch panels, featuring human-machine interactions, are extensively applied in electronic products including smart phones, GPS navigator systems, tablet computers and laptop computers. A touch sensing element in a conventional mutual capacitive touch panel is formed by a plurality of driving electrodes and a plurality of sensing electrodes in a staggered arrangement. The driving electrodes and the sensing electrodes are formed by two conductive layers to prevent these two types of electrodes from electrically connecting to each other. To form a mutual capacitive touch sensing device using the two conductive layers, an insulation layer is required in between to insulate the two layers from each other. However, the additional insulation layer inevitably restricts the thickness of the touch panel. Therefore, a single-layer mutual capacitive touch sensing device has been developed.

A conventional mutual capacitive touch sensing element having a single-layer structure is formed by sensing electrodes and driving electrodes, and each of the sensing electrodes is disposed correspondingly to one driving electrode to cause each driving electrode together with different parts of the sensing electrodes to form one sensing unit. Although the single-layer touch sensing element helps reducing the thickness of a touch panel, each sensing electrode and each driving electrode of such design need to be respectively electrically connected to corresponding pads via conductive wires. Thus, compared to two-layer touch sensing element, the number of pads is significantly increased, which causes an excessive load on driving elements. Further, a flexible circuit board for electrically connecting pads and driving elements needs to be designed with a larger amount of routings and a greater area, leading to increased manufacturing costs and design difficulties of the flexible circuit board.

### SUMMARY OF THE INVENTION

The invention is directed to a mutual capacitive touch panel to reduce the number of pads.

According to an embodiment of the present invention, a mutual capacitive touch panel includes a substrate and at least one touch sensing group. The substrate includes a first side and a second side that are opposite each other. The touch sensing group extends along a first direction on the substrate, and includes a plurality of first electrodes, a plurality of second electrodes, a plurality of third electrodes and a plurality of fourth electrodes. The first electrodes are arranged along the first direction, and are electrically connected to one another. The second electrodes are arranged along the first direction, and are electrically connected to one another. The third electrodes are arranged along the first direction, and are disposed at one side of the corresponding first electrodes facing the first side to together with the corresponding first electrode form a first sensing unit. The fourth electrodes are arranged along the first direction, and are disposed at one side of the corresponding second electrodes facing the second side to together with the corresponding second electrode form a second sensing unit. The third electrodes are electrically connected to the adjacent fourth electrodes.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a top view of a mutual capacitive touch panel according to a first embodiment of the present invention;

FIG. 2 is a top view of a mutual capacitive touch panel according to a second embodiment of the present invention;

FIG. 3 is a top view of a mutual capacitive touch panel according to a third embodiment of the present invention;

FIG. 4 is a top view of a mutual capacitive touch panel according to a fourth embodiment of the present invention; and

FIG. 5 is a top view of a mutual capacitive touch panel according to a fifth embodiment of the present invention.

### DETAILED DESCRIPTION OF THE INVENTION

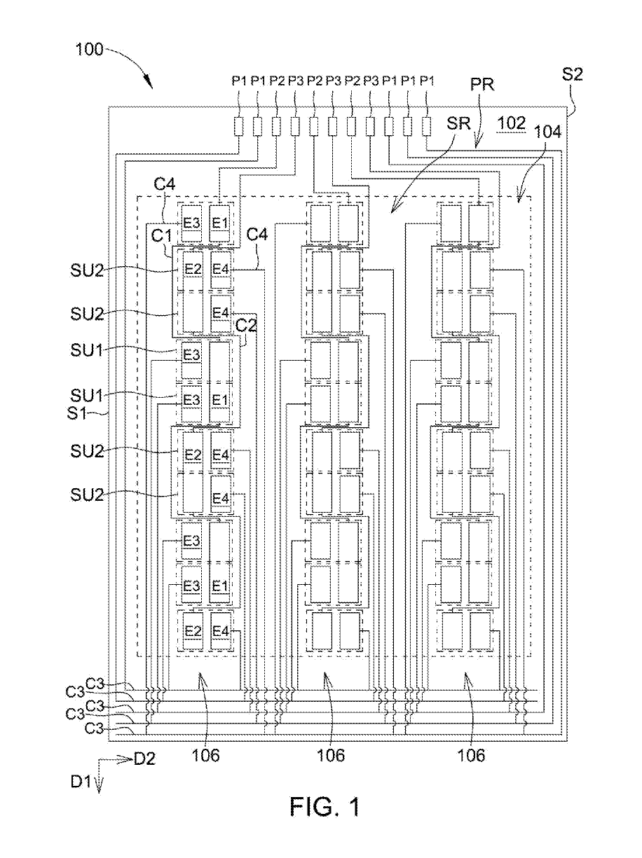

FIG. 1 shows a top view of a mutual capacitive touch panel according to a first embodiment of the present invention. To clearly depict the structure of the mutual capacitive touch panel, the touch panel in FIG. 1 is only exemplary and is not limited to the drawn size and ratio. As shown in FIG. 1, a mutual capacitive touch panel 100 of this embodiment includes a substrate 102 and a touch sensing element 104. The substrate 102 includes a first side S1 and a second side S2 that are opposite to each other, and may further include a sensing region SR and a peripheral region PR. In this embodiment, the peripheral region PR, for example but not limited to, surrounds the sensing region SR. For example, the substrate 102 may include a hard substrate or a flexible substrate, e.g., a glass substrate, a reinforced glass substrate, a sapphire substrate, a hard cover lens, a plastic substrate, a flexible cover lens, a flexible plastic substrate, a thin glass substrate or a substrate of a display. Wherein, the substrate of a display may be, for example but not limited to, a color filter lens of a liquid crystal display (LCD) or a packaging cover lid of an organic light emitting diode (OLED) display. The touch sensing element 104 is disposed on the substrate 102, and includes at least one touch sensing group 106 extending along a first direction D1. In this embodiment, the touch sensing element 104 may include a plurality of touch sensing groups 106 arranged along a second direction D2.

Each of the touch sensing groups 106 includes a plurality of first electrodes E1, a plurality of second electrodes E2, a plurality of third electrodes E3 and a plurality of fourth electrodes E4 disposed in the sensing region SR on the substrate 102. With respect to one touch sensing group 106, the first electrodes E1 and the second electrodes E2 are sequentially alternately arranged along the first direction D1. Wherein, the first electrodes E1 are electrically connected to one another, the second electrodes E2 are electrically connected to one another, and the first electrodes E1 and the second electrodes E2 are electrically insulated. More specifically, each touch sensing group 106 may further include a plurality of first connecting lines C1 and a plurality of second connecting lines C2 disposed in the sensing region SR on the substrate 102. Each of the first connecting lines C1 is connected between any two adjacent first electrodes E1, and extends to one side of the corresponding electrode E2 facing the first side S1 to electrically connect in series the first electrodes E1 of the same touch sensing group 106 to a first electrode series. Each of the second connecting lines C2 is connected between any two adjacent second electrodes E2, and extends to one side of the corresponding electrode E1 facing the second side S2 to electrically connect in series the second electrodes E2 of the same touch sensing group 106 to a second electrode series.

The third electrodes E3 are arranged along the first direction D1 and are electrically insulated from one another. Further, each of the third electrode E3 is disposed at one side of the corresponding first electrode E1 facing the first side S1, and is spaced by a gap from a part of the corresponding first electrode E1 to generate capacitance coupling, such that each of the third electrodes E3 and a part of the corresponding first electrode E1 form a first sensing unit SU1. The fourth electrodes E4 are arranged along the first direction D1, and are electrically insulated from one another. Furthermore, each of the fourth electrodes E4 is disposed at one side of the corresponding second electrode E2 facing the second side S2, and is spaced by a gap from a part of the corresponding second electrode E2 to generate capacitance coupling, such that each of the fourth electrodes E3 and a part of the second electrode E2 form a second sensing unit SU2. It should be noted that, each third electrode E3 is electrically connected to the adjacent fourth electrode E4 to form an electrode unit. Furthermore, among the third electrodes E3 arranged in the second direction D2, those located at the same row but in different touch sensing groups 106 are electrically connected to one another; among the fourth electrodes E4 arranged in the second direction D2, those located at the same row but in different touch sensing groups 106 are also electrically connected to one another. Thus, the electrodes units located at the same row and arranged in the second direction D2 may be electrically connected to one another to form a third electrode series. Because the adjacent and electrically connected third electrode E3 and fourth electrode E4 are disposed correspondingly to the adjacent first electrode E1 and second electrode E2, each electrode unit overlaps a part of the first electrode E1 and a part of the second electrode E2 in the second direction E2 to generate capacitance coupling. Thus, the same electrode unit together with the first electrode E1 and the second electrode E2 respectively form different sensing units; that is, the adjacent first sensing unit SU1 and second sensing unit SU2 may be respectively formed by the same electrode unit and the adjacent first electrode E1 and second electrode E2 through coupling, thereby reducing the number of pads of the touch sensing element 104. For example, assume that one touch sensing group 106 includes 20 sensing units, and there are a total of 12 touch sensing groups; that is, 20×12 touch sensing units are taken for instance. In this embodiment, the touch sensing element 104 needs only 34 pads for transmitting and receiving signals. More specifically, the third electrodes E3 and the fourth electrodes E4 of all of the touch sensing groups 106 use 20/2=10 pads, and each of the first electrodes E1 and the second electrodes E2 in each of the touch sensing groups 106 uses 1 pad, totaling up to 10+2*12=34 pads. In a conventional touch sensing element, because each of the sensing electrodes and driving electrodes needs to be electrically connected to a corresponding pad, in the example of 20×12 sensing units, 264 pads are needed. More specifically, each of the third electrodes E3 and the fourth electrodes E4 in the 20 sensing units of each of the touch sensing groups 106 requires 1 pad. Furthermore, each of the first electrode series and second electrode series in each of the touch sensing groups 106 requires 1 pad. Thus, there are a total of (20+2)*12=264 pads. It is thus known that, the touch sensing element 104 of the embodiment significantly reduces the number of pads. It should be noted that, the fourth electrode E4 adjacent to each of the third electrodes E3 refers to the fourth electrode E4 that is distanced nearest to each of the third electrodes E3.

Furthermore, the third electrodes E3 and the fourth electrodes E4 of the embodiment may be driving electrodes. Because each of the third electrodes E3 is electrically connected to the adjacent fourth electrode E4 to form an electrode unit, each electrode unit may be regarded as one single driving electrode and is for receiving a driving signal. The first electrodes E1 and the second electrodes E2 may be sensing electrodes, and are for generating corresponding sensing signals as a result of capacitance coupling when the corresponding electrode units receive the driving signals. Taking one touch sensing group 106 for instance, when touch detection is performed, a control element sequentially transmits driving signals to the electrode units, and receives the corresponding sensing signals from the first electrode series formed by the first electrodes E1 connected in series and the second electrode series formed by the second electrodes E2 connected in series. Since the electrode units together with the first electrodes E1 and the second electrodes E2 may generate capacitance coupling to respectively form different sensing units, the corresponding first electrodes E1 and second electrodes E2 may respectively generate sensing signals when one driving signal is generated to an electrode unit, thereby achieving detection of two sensing units. It is thus known that, the touch sensing element 104 of this embodiment effectively reduces the number of driving signals to further alleviate the load on the control element. In another embodiment, the first electrodes E1 and the second electrodes E2 may be driving electrodes, and the third electrodes E3 and the fourth electrodes E4 may be sensing electrodes. One person skilled in the art can understand that the above operation characteristic is applicable to all embodiments of the present invention, and shall be omitted hereafter.

More specifically, every two adjacent third electrodes E3 are disposed correspondingly to one first electrode E1 and overlap the corresponding first electrode E1 in the second direction E2 to form two adjacent first sensing units SU1. Every two adjacent fourth electrodes E4 are disposed correspondingly to one second electrode E2 and overlap the corresponding second electrode E2 in the second direction D2 to form two adjacent sensing units SU2. Every two adjacent second sensing units SU2 and every two first sensing units SU1 are sequentially alternately arranged along the first direction D1, and the first sensing units SU1 and the second sensing units SU2 may be arranged in an array to further perform touch detection on a position or a moving trajectory of a touch object. Further, in this embodiment, the first electrodes E1 and the second electrodes E2 have displacement in the second direction D2, and the adjacent third electrodes E3 and fourth electrodes E4 also have the same displacement in the second direction D2, such that the first sensing unit SU1 and the second sensing unit SU2 of one touch sensing group 106 may be arranged in a straight line to accurately detect the position of a touch object.

In this embodiment, the touch panel 100 may further include a plurality of third connecting lines C3 are disposed at one side of the touch sensing group 106, and each of the third electrodes E3 is electrically connected to the adjacent fourth electrode E4 via one corresponding third connecting line C3. More specifically, the third connecting lines C3 may be disposed in the peripheral region PR on the substrate 102, preferably at one end side of the touch sensing group 106, such that the third connecting lines C3 may extend along the second direction D2 to further connect the third electrodes E3 located at the same row and the fourth electrodes E4 located in the same row in different touch sensing groups 106. For example, the third electrodes E3 located in the same row may be electrically connected to one another via the same third connecting line C3, when the fourth electrodes E4 located at the same row are adjacent to the third electrodes E3 located at the same row, the fourth electrodes E4 at this row and the adjacent third electrodes E3 are electrically connected to the same third connecting line C3. Further, each of the touch sensing groups 106 may further include a plurality of fourth connecting lines C4 that extend from the sensing region SR to the peripheral region PR. Each of the third electrodes E3 may connect to the corresponding third connecting line C3 via one corresponding fourth connecting line C4, and each of the fourth electrodes E4 may connect to the corresponding third connecting line C3 via another corresponding fourth connecting line C4. In this embodiment, the fourth connecting lines C4 extend along the first direction D1, and only connect to the corresponding third connecting lines C3. Thus, a part of the fourth connecting lines C4 cross the third connecting lines C3 through the insulation structure instead of being insulated from the corresponding third connecting lines C3, so as to further connect to the corresponding third connecting lines C3. For example, the third connecting lines C3 and the fourth connecting lines C4 may be formed by different conductive layers, and an insulation layer may be disposed in between, for example. Through the design of the third connecting lines C3 and the fourth connecting lines C4, in the same electrode unit, the third electrodes E3 disposed at one side of the first electrodes E1 facing the first side S1 and the fourth electrodes E4 disposed at one side of the second electrodes E2 facing the second side S2 may be electrically connected to one another. Furthermore, by disposing the third electrodes E3 and the fourth electrodes E4 at one side of the first electrodes E1 facing the first side S1 and one side of the second electrodes E2 facing the second side S2, the first connecting line C1 connecting two adjacent first electrodes E1 may extend from between the third electrode E3 and the second electrode E2 to one side of the second electrode E2 facing the first side S1 instead of being disposed between the second electrode E2 and the fourth electrode E4, thereby preventing the signal on the first connecting line C1 from interfering or reducing a capacitance coupling change between the second electrode E2 and the fourth electrode E4. Similarly, the second connecting line C2 may extended from between the fourth electrode E4 and the first electrode E1 to one side of the first electrode E1 facing the second side S2 instead of being disposed between the first electrode E1 and the third electrode E3, thereby preventing the signal on the second connecting line C2 from interfering or reducing a capacitance coupling change between the first electrode E1 and the third electrode E3. As such, the touch sensing element 140 of this embodiment is capable of maintaining a certain value of coupling capacitance, i.e., providing an outstanding touch sensing amount, so as to not only reduce the interference of noise on the touch sensing element to provide a better signal-to-noise ratio (SNR) but also cause the sensing units to have consistent coupling capacitances to prevent the touch control sensitivity from changing with the position.

Furthermore, a width of the third electrodes E3 in the first direction D1 is smaller than a width of the first electrodes E1 in the first direction D1, and maybe approximately ½ of the first electrodes D1 in the first direction D1, for example but not limited thereto. A width of the fourth electrodes E4 in the first direction D1 is smaller than a width of the second electrodes E2 in the first direction D1, and may be approximately ½ of the width of the second electrodes E2 in the first direction D1, for example but not limited to. Preferably, the widths of the first electrodes E1 and the second electrodes E2 in the first direction D1 may be equal, and the widths of the third electrodes E3 and the fourth electrodes E4 in the first direction D1 may be equal, for example but not limited thereto.

In this embodiment, the first electrodes E1, the second electrodes E2, the third electrodes E3, the fourth electrodes E4, the first connecting lines C1, the second connecting lines C2 and the fourth connecting lines C4 may be formed by patterning the same transparent conductive layer, and may thus be disposed on the same plane to form a so-called single-layer structure. For example, the transparent conductive layer may be indium tin oxide (ITO), indium zinc oxide (IZO), aluminum zinc oxide (AZO) or other transparent conductive materials.

The touch panel 100 may further include a plurality of first pads P1, a plurality of second pads P2, and a plurality of third pads P3. Each of the third connecting lines C3 may extend to electrically connect one first corresponding first pad P1. The first electrodes E1 of each of the touch sensing groups 106, i.e., each of the first electrode series, may have one end electrically connect to one corresponding second pad P2 via a conductive line; the second electrodes E2 of each of the touch sensing groups 106, i.e., the second electrode series, may have one end electrically connected to one correspond third pad P3 via a conductive line. The touch panel 100 may further include ground lines G and ground pads GP. The ground lines G may be disposed around the touch sensing groups, as well as between the third connecting lines C3 and conductive lines connecting the second pads P2 and the first electrode series, or between the third connecting lines C3 and the conductive line connecting the third pads P3 and the second electrode series, so as to prevent the touch sensing element from ESD damages and preventing the first electrodes E1 and the second electrodes E2 from interference of the signals on the third connecting lines C3. The first pads P1, the second pads P2, the third pads P3 and the ground pads of the touch panel 100 may further be electrically connected to the control element via a flexible circuit board, so as to transmit the driving signals to the touch sensing element 104 and to receive the sensing signals from the touch sensing element 104 to determine a position or operation of a touch object.

For each of the first sensing units SU1 or the second sensing units SU2 of the mutual capacitive touch panel 100, the basis for correctly determining a position or an operation of a touch object is that, in the entire mutual capacitive touch panel 100, only that first sensing unit SU1 or second sensing unit SU2 simultaneously corresponds to the pads corresponding to the driving electrodes included or the pads corresponding to the sensing electrodes included. Therefore, the logic of the present invention may be summarized as: 1) in the same touch sensing group 106, the third electrodes E3 corresponding to the first electrode series need to be connected to different pads, and the fourth electrodes E4 corresponding to the second electrode series need to be connected to different pads; 2) in the same touch sensing group 106, the adjacent third electrodes E3 and fourth electrodes E4 in the first direction D1 may be electrically connected to share the same pad as they respectively correspond to the first electrode series and the second electrode series; and 3) because the first electrode series and the second electrode series of different touch sensing groups 106 correspond to different pads, in different touch sensing groups 106, the third electrode E3 and the fourth electrodes E4 having the same positions in the second direction D2 may be electrically connected to share the same pad.

It should be noted that, the adjacent and electrically connected third electrodes E3 and fourth electrodes E4 are respectively disposed at one side of the first electrodes E1 facing the first side S1 and one side of the second electrodes E2 facing the second side S2. Thus, the first electrode E1 and the second electrode D2 corresponding to each of the electrode units may respectively generate two sensing signals with respect to one driving signal, so as to achieve detection of two sensing units and to further reduce the number of driving signals transmitted to alleviate the load on the control element. Further, among the third electrodes E3 of different touch sensing groups 106, by electrically connecting those located at the same row and arranged in the second direction D2, the numbers of the first pads P1, the second pads P2 and the third pads P3 needed by the touch sensing element 104 of the embodiment may be more effectively reduced. It is then known that, the number of pads of the touch panel 100 of the embodiment is significantly reduced, thereby not only alleviating the load on the control element but also reducing production costs and simplifies the design of the flexible circuit board. Further, with the design of the touch sensing element 104 of the embodiment, the linearity that the touch sensing element 104 detects for a touch object moving along a straight line is also enhanced, and errors in the first direction D1 and the second direction D2 can both be smaller than 1 mm.

The mutual capacitive touch panel of the present invention is not limited to the above embodiment. In the following description, other and variation embodiments are sequentially given. To better compare the embodiments and differences between the embodiments in brevity, the same denotations are used to represent the same elements in the embodiments and the variation embodiments below. Further, the following description focuses on the differences of the embodiments and the variation embodiments, and the repeated details are omitted herein.

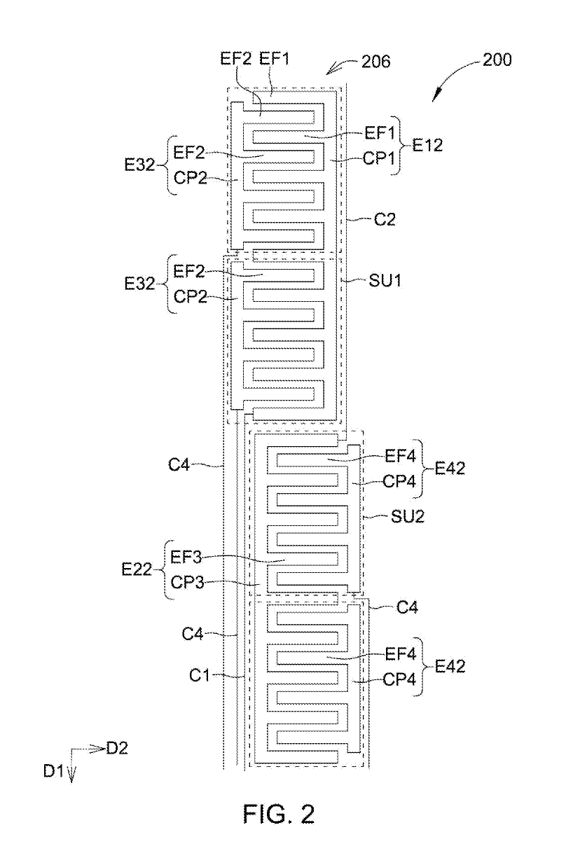

FIG. 2 shows a top view of a mutual capacitive touch panel according to a second embodiment of the present invention. To clearly show the structure of the embodiment, FIG. 2 depicts only a part of first sensing units and second sensing units of one touch sensing group, and the present invention is not limited thereto. As shown in FIG. 2, some differences of a touch panel 200 of the embodiment from the touch panel of the first embodiment are that, each of the first electrodes E12 of each of the touch sensing groups 206 includes a first connecting portion CP1 and a plurality of first electrode fingers EF1. The first electrode fingers EF1 extend along a direction opposite the second direction D2 from the first connecting portion CP1, such that the first electrode E12 appears comb-like, and an opening of the comb-like first electrode E12 faces a direction opposite the second direction D2. Further, each of the third electrodes E32 includes a second connecting portion CP2 and a plurality of second electrode fingers EF2. The second electrode fingers EF2 extend along the second direction D2 from the second connecting portion CP2, such that the third electrode E32 also appears comb-like, and an opening of the comb-like third electrode E32 faces the second direction D2. Further, each of the second electrode fingers EF2 extends to between any two adjacent first electrode fingers EF1. Thus, compared to the first embodiment, capacitance coupling regions between the first electrodes E12 and the third electrodes E32 are increased, so as to increase the coupling capacitance between the first electrodes E12 and the third electrodes E32. Similarly, each of the second electrodes E22 includes a third connecting portion CP3 and a plurality of third electrode fingers EF3. The third electrode fingers EF1 extend along the second direction D2 from the third connecting portion CP3. Each of the fourth electrodes E42 includes a fourth connecting portion CP4 and a plurality of fourth electrode fingers EF4. Each of the fourth electrode fingers EF4 extends along a direction opposite to the second direction D2 from the fourth connecting portion CP4 to between any two adjacent third electrode fingers EF3, and so the coupling capacitance between the second electrodes E22 and the fourth electrodes E42 can be increased and to further increase the coupling capacitance when the touch sensing group 206 detects a touch object, thereby enhancing the touch control sensitivity of the touch panel 200. In this embodiment, the first electrodes E12 the second electrodes E22 are not displaced in the second direction D2 and are arranged on a straight line. In another embodiment, the first electrode fingers EF1 and the third electrode fingers EF3 may also extend along the first direction D1, and the second electrode fingers EF2 and the fourth electrode fingers EF4 may extend along a direction opposite to the first direction D1.

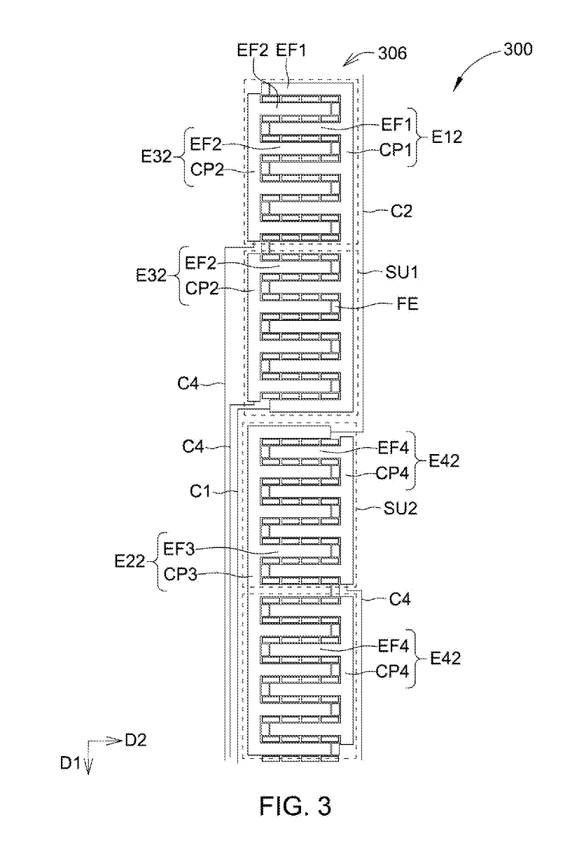

FIG. 3 shows a top view of a mutual capacitive touch panel according to a third embodiment of the present invention. To clearly show the structure of the present invention, FIG. 3 depicts only a part of the first sensing units and second sensing units of one touch sensing group, but the present invention is not limited thereto. As shown in FIG. 3, some differences of a touch panel 300 of the embodiment from the touch panel of the second embodiment are that, each of the touch sensing groups 306 of the embodiment further includes a plurality of floating electrodes FE, which are disposed between the third electrodes E32 and the corresponding first electrodes E12 and between the fourth electrodes E42 and the corresponding second electrodes E22. By disposing the floating electrodes FE at gaps between the first electrodes E12 and the third electrodes E32 and at gaps between the second electrodes E22 and the fourth electrodes E42, coupling capacitances between the first electrodes E12 and the third electrodes E32 and coupling capacitances between the second electrodes E22 and the fourth electrodes E42 may be effectively increased to further enhance the touch control sensitivity. In this embodiment, the first electrodes E1 and the second electrodes E2 are slightly displaced in the second direction D2, which is a result of adapting to the first sensing units SU1 and the second sensing units SU2 of one touch sensing group 106 that are arranged on a straight line. Thus, regions in the touch sensing group 306 that are not filled with electrodes can be reduced, and the touch sensing group 306 may be given a more regular shape to accurately detect a position of a touch object.

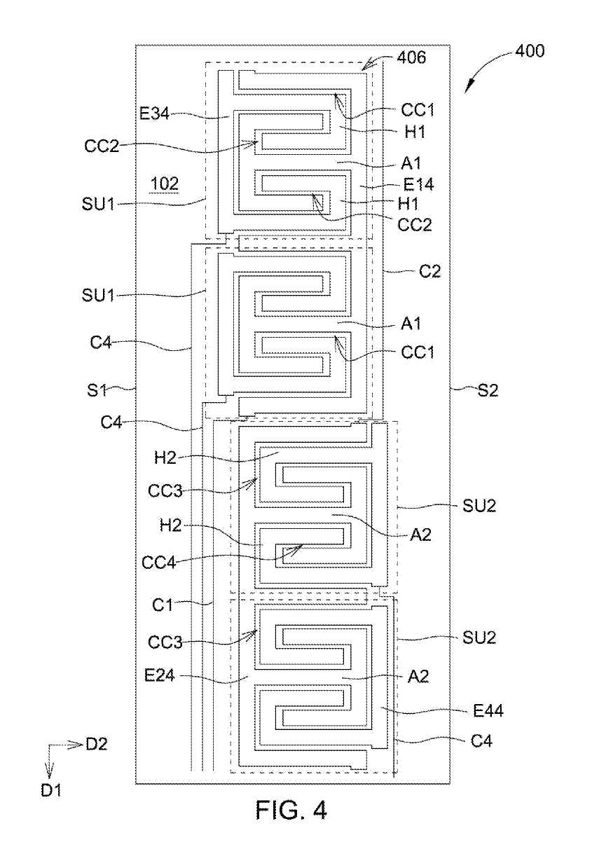

FIG. 4 shows a top view of a touch panel according to a fourth embodiment of the present invention. To clearly show the structure of the present invention, FIG. 4 depicts only a part of the first sensing units and second sensing units of one touch sensing group, but the present invention is not limited thereto. As shown in FIG. 4, some difference of a touch panel 400 of the embodiment from the touch panel of the first embodiment are that, each of the first electrodes E14 of a touch sensing group 406 includes two recesses CC1 facing the first side S1, i.e., the recesses CC1 are disposed facing a direction opposite the second direction D2, and every two adjacent third electrodes E34 respectively extend into the recesses CC1. Further, each of the first electrodes E14 includes two anchor portions A1 respectively disposed in the corresponding recesses CC1. Each of the anchor portions A1 includes two recesses CC2 disposed facing the second direction D2. Each of the third electrodes E34 includes two hook portions H1 respectively extending into the corresponding recesses CC2, thereby increasing the coupling capacitance between the first electrodes E14 and the third electrodes E34. Similarly, each of the second electrodes E24 includes two recesses CC3 facing the second side S2, i.e., the recesses CC3 are disposed facing the second direction D2, and every two adjacent fourth electrodes E44 respectively extend into the corresponding recesses CC3. Further, each of the second electrodes E24 includes two anchor portions A2 respectively disposed in the corresponding recesses CC3. Each of the anchor portions A2 includes two recesses CC4 disposed facing a direction opposite the second direction D2. Further, each of the fourth electrodes E44 includes two hook portions H2 respective extending into the corresponding recesses CC4. Accordingly, the coupling capacitance when the touch sensing group 406 detects a touch object can be increased to enhance the touch control sensitivity of the touch panel 400.

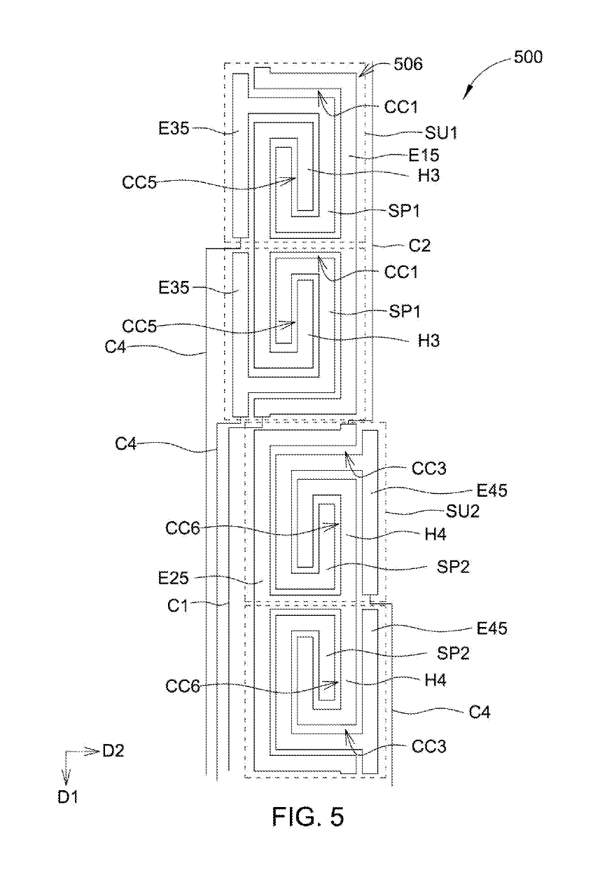

FIG. 5 shows a top view of a mutual capacitive touch panel according to a fifth embodiment of the present invention. To clearly show the structure of the present invention, FIG. 5 depicts only a part of the first sensing units and second sensing units of one touch sensing group, but the present invention is not limited thereto. As shown in FIG. 5, some differences of a touch panel 500 of the embodiment and the touch panel of the fourth embodiment are that, each of the first electrodes E15 of the embodiment includes two hook portions H3 that replace the anchor portions. The hook portions H3 are respectively disposed in the corresponding recesses CC1, and extend from sidewalls of the recesses CC1. For example, the shape of the hook portions H3 of each of the first electrodes E15 is symmetrical to the second direction D2, and so the hook portions H3, respectively extend along a direction opposite the first direction D1 and the first direction D1 from the corresponding recesses CC1. It should be noted that the present invention is not limited thereto. In another embodiment, the hook portions H3 of each of the first electrodes E15 may have the same shape. More specifically, each of the hook portions H3 of each of the first electrodes E15 may include a recess CC5, and the recesses CC5 extend respectively towards the first direction D1 and a direction opposite the first direction D1. Each of the third electrodes E35 includes a spiral portion SP1 extending into the corresponding recess CC5, thereby accordingly increasing the coupling capacitance between the first electrodes E15 and the third electrodes E35. Similarly, each of the second electrodes E25 may include two hook portions H4 respectively disposed in the corresponding recesses CC3. For example but not limited to, each of the hook portions H4 may extend in a symmetrical manner to the second direction D2 from a sidewall of the corresponding recess CC3. In another embodiment, the hook portions H4 of each of the second electrodes E25 may have the same shape. Each of the hook portions H4 includes a recess CC6, and each of the fourth electrodes E45 includes a spiral portion SP2 extending into the corresponding recess CC6. Accordingly, the coupling capacitances when the touch sensing group 506 detects a touch object can be increased to enhance the touch control sensitivity of the touch panel 500.

In conclusion, in the mutual capacitive touch panel of the present invention, the adjacent third electrodes and fourth electrodes are electrically connected to one another and respectively correspond to the adjacent first electrodes and second electrodes. Thus, in the second direction, the electrode units formed may overlap a part of the first electrodes and a part of the second electrodes. Further, by electrically connecting the third electrodes located in the same row and electrically connecting the fourth electrodes located in the same row, the number of pads needed by the touch panel is effectively reduced. Thus, not only the load on the control element is alleviated, production costs of a flexible circuit board can be saved, and the design of the flexible circuit board can be simplified, but also the linearity that the touch sensing element detects for a touch object moving along a straight line is also enhanced. Further, because the first connecting lines may extend to one side of the second electrodes facing the first side and the second connecting lines may extend to one side of the first electrodes facing the second side, signals on the first connecting lines and the second connecting lines are prevented from interfering or reducing capacitance coupling amounts between the second electrodes and the fourth electrodes and between the first electrodes and the third electrodes.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A mutual capacitive touch panel, comprising:
a substrate, having a first side and a second side that are opposite; and
at least one touch sensing group, extending along a first direction on the substrate, comprising:
a plurality of first electrodes, electrically connected to one another;
a plurality of second electrodes, electrically connected to one another, wherein the first electrodes and the second electrodes are sequentially alternately arranged along the first direction;
a plurality of third electrodes, arranged along the first direction, wherein one of the third electrodes is disposed at one side of one corresponding of the first electrodes facing the first side, and forms a first sensing unit with the corresponding first electrode; and
a plurality of fourth electrodes, arranged along the first direction, wherein one of the fourth electrodes adjacent to the third electrode is disposed at one side of one corresponding of the second electrodes facing the second side, forms a second sensing unit with the corresponding second electrode, and the third electrode and the adjacent fourth electrode are electrically connected.

2. The mutual capacitive touch panel according to claim 1, wherein the at least one touch sensing group further comprises a plurality of first connecting lines and a plurality of second connecting lines, each of the first connecting lines is connected between adjacent two of the first electrodes and extends to one side of one corresponding of the second electrodes facing the first side, and each of the second connecting lines is connected between adjacent two of the second electrodes and extends to one side of one corresponding of the first electrodes facing the second side.

3. The mutual capacitive touch panel according to claim 1, comprising a plurality of the touch sensing groups arranged along a second direction, wherein in the touch sensing groups, the third electrodes located at the same row and arranged in the second direction are electrically connected to one another.

4. The mutual capacitive touch panel according to claim 3, further comprising a plurality of third connecting lines disposed at one side of the touch sensing groups, wherein the third electrodes located in the same row and the adjacent fourth electrodes are electrically connected via the same third connecting line.

5. The mutual capacitive touch panel according to claim 4, further comprising a plurality of first pads, a plurality of second pads and a plurality of third pads, the third connecting lines are electrically connected to one corresponding of the first pads, the first electrodes of the touch sensing groups are electrically connected to one corresponding of the second pads, and the second electrodes of the touch sensing groups are electrically connected to one corresponding of the third pads.

6. The mutual capacitive touch panel according to claim 4, wherein each of the touch sensing groups further comprises a plurality of fourth connecting lines, each of the third electrodes is connected to the corresponding third connecting line via one corresponding of the fourth connecting lines, and each of the fourth electrodes is electrically connected to the corresponding third connecting line via another corresponding of the fourth connecting lines.

7. The mutual capacitive touch panel according to claim 1, wherein each of the first electrodes comprises a plurality of first electrode fingers, each of the third electrodes comprises a plurality of second electrode fingers, and each of the second electrode fingers extends between adjacent two of the first electrode fingers.

8. The mutual capacitive touch panel according to claim 1, wherein each of the second electrodes comprises a plurality of third electrode fingers, each of the fourth electrodes comprises a plurality of fourth electrode fingers, and each of the fourth electrode fingers extends between adjacent two of the third electrode fingers.

9. The mutual capacitive touch panel according to claim 1, wherein the at least one touch sensing group further comprises a plurality of floating electrodes, which are disposed between each of the third electrodes and the corresponding first electrode and between each of the fourth electrodes and the corresponding second electrode.

10. The mutual capacitive touch panel according to claim 1, wherein each of the first electrodes comprises two first recesses facing the first side, and the two adjacent third electrodes respectively extend into the corresponding first recesses.

11. The mutual capacitive touch panel according to claim 10, wherein each of the first electrodes comprises two anchor portions respectively disposed in the corresponding first recesses, each of the anchor portions comprises two second recesses, and each of the third electrodes comprises two hook portions respectively extending into the corresponding second recesses.

12. The mutual capacitive touch panel according to claim 10, wherein each of the first electrodes comprises two hook portions respectively disposed in the corresponding first recesses, each of the hook portions comprises a fifth recess, and each of the third electrodes comprises a spiral portion extending into the corresponding fifth recess.

13. The mutual capacitive touch panel according to claim 1, wherein each of the second electrodes comprises two third recesses facing the second side, and adjacent two of the fourth electrodes respectively extend into the corresponding third recesses.

14. The mutual capacitive touch panel according to claim 13, wherein each of the second electrodes comprises two anchor portions respectively disposed in the corresponding third recesses, each of the anchor portions comprises two fourth recesses, and each of the fourth electrodes comprises two hook portions respectively extending into the corresponding fourth recesses.

15. The mutual capacitive touch panel according to claim 13, wherein each of the second electrodes comprises two hook portions respectively disposed in the corresponding third recesses, each of the hook portions comprises a sixth recess, and each of the fourth electrodes comprises a spiral portion extending into one corresponding of the sixth recesses.

16. The mutual capacitive touch panel according to claim 1, wherein the first electrodes, the second electrodes, the third electrodes and the fourth electrodes of the at least one touch sensing group are formed by patterning the same transparent conductive layer.

17. The mutual capacitive touch panel according to claim 1, wherein the first electrodes and the second electrodes are sensing electrodes, and the third electrodes and the fourth electrodes are driving electrodes.

18. The mutual capacitive touch panel according to claim 1, wherein the first electrodes and the second electrodes are driving electrodes, and the third electrodes and the fourth electrodes are sensing electrodes.
